(19) United States
(12) Patent Application Publication
(10) Pub. No.: US 2009/0014087 A1
(43) Pub. Date: Jan. 15, 2009

(54) Fuel spillage interceptor

(76) Inventor: Jonny Fevag, Langhus (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/091,424

(22) PCT Filed: Oct. 26, 2006
(86) PCT No.: PCT/NO2006/000377

§ 371 Date: Sep. 5, 2008

(30) Foreign Application Priority Data
Oct. 26, 2005 (NO) 20054964

(51) Int. Cl. B67D 5/378

(52) U.S. Cl. 141/86; 222/108

(57) ABSTRACT

A liquid absorbent device in the form of a fuel spillage interceptor arranged for mounting on a fuel dispensing nozzle, the fuel spillage interceptor being arranged to enclose a portion of the spout of the dispensing nozzle, and where an essentially annular body is formed by a cloth that is permeable to liquid, and which defines a volume of at least one liquid absorbent material.

The invention regards a fuel absorbing device arranged to enclose a spout of a fuel dispensing nozzle, in particular for diesel and other types of low-volatility fuels, the device constituting an annular object defined by a material that is permeable to liquids and filled with an absorbent material.

It is a commonly known problem that the dispensing nozzles on e.g. pumps used for filling up cars with fuel, suffer from a certain amount of dripping when the nozzle is moved from the pump to the filling tube of the car, and even more so when removing the dispensing nozzle from the car upon completion of filling. In the case of volatile fuels such as petrol this does not present a significant problem, as whatever fuel has been spilled on the outside of the dispensing nozzle, surrounding equipment, the ground and on the clothes and skin of the operator, will quickly evaporate without leaving any significant residue or causing any significant nuisance effects. Less volatile fuels such as diesel oil present a bigger problem, as any spilled fuel will soil whatever it comes into contact with, as well as causing long lasting olfactory pollution when spilled on e.g. the operator's clothes and skin.

An annular absorbent body is used to a certain extent to capture such spillage, the body being provided around the spout of the dispensing nozzle. The absorbent body is made from a sponge-like material such as foam rubber. The solutions used here quickly exhibit a condition in which the absorbed fuel has wetted the surface of the absorbent body, and so fuel is easily transferred to other bodies upon contact. The materials used for the absorbent body of prior art also shows a strong tendency to drip fuel when the absorbent body is nearing saturation. This increases the risk of pollution. Also, the capacity for absorption is inadequate, especially when the material is exposed to e.g. precipitation which is absorbed to a great extent, as the capacity of the pores is taken up by water instead of fuel residue.

The object of the invention is to remedy or reduce at least one of the drawbacks of prior art.

The object is achieved through features given in the description below and in the following claims.

The invention regards a liquid absorbent device in the form of a fuel spillage interceptor arranged for mounting on a fuel dispensing nozzle, the fuel spillage interceptor being arranged to enclose a portion of the spout of the dispensing nozzle, and where a cloth permeable to liquid forms an essentially annular body, which cloth defines a volume filled with at least one hydrocarbon liquid absorbent material.

Preferably the at least one hydrocarbon liquid absorbent material is organic.

Preferably the at least one hydrocarbon liquid absorbent material is particulate.

Preferably the at least one hydrocarbon liquid absorbent material is desiccated hydrophobic sphagnum peat.

Preferably the at least one hydrocarbon liquid absorbent material is Biomatrix Gold™ from the manufacturer Biomatrix Gold™, Garth Barrett, Unit C12, Century Square, Heron Crescent, Century City, 7441 (Canada), a natural organic absorbent made from peat which is formed from sphagnum moss, which upon desiccation goes from being hydrophilic to becoming hydrophobic. Thus the material does not absorb water, and the hydrocarbon liquid absorbent device of the invention maintains its intended function even when exposed to precipitation. Biomatrix Gold™ absorbs ten times its own weight in hydrocarbons without leaking. The material will also to a great extent prevent the absorbed hydrocarbons from evaporating (up to 90% for petrol). With time, humic matter and microbes that occur naturally in the sphagnum peat will break down the hydrocarbons. Consequently, used material can be composted and recycled, or alternatively used as a source of energy in a combustion process.

The following describes a non-limiting example of a preferred embodiment illustrated in the accompanying drawings, in which:

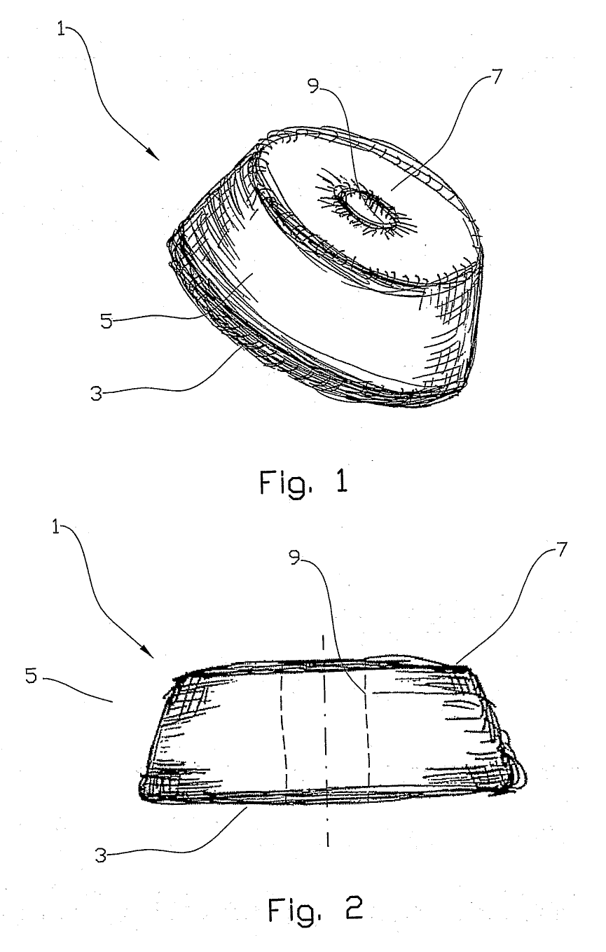

FIG. 1 is a perspective view of a fuel spillage interceptor according to the invention; and

FIG. 2 is a side view of the fuel spillage interceptor.

Reference is made to FIGS. 1 and 2, in which a fuel spillage interceptor 1 formed as a truncated cone exhibits a first end face 3, a side face 5 and a second end face 7. Between the first and second end faces 3, 7 there extends a cylindrical through opening defined by a cylindrical wall 9, the centre line of the opening essentially coinciding with the centre line of the truncated cone. The cylindrical opening has a diameter which is a complementary match to the diameter of the spout of a dispensing nozzle (not shown).

All the faces 3, 5, 7, 9 are formed from a continuous piece of cloth. The cloth has a structure which is permeable to liquids. Preferably the materials of the cloth do not absorb or adsorb liquid hydrocarbons. Advantageously the cloth is elastic, especially the cloth that forms the cylinder wall 9, as this provides the fuel spillage interceptor with favourable characteristics when it comes to fitting the fuel spillage interceptor 1 to the spout of the dispensing nozzle. The various cloth elements that are used to form the faces 3, 5, 7, 9 are joined in a manner that is known per se, by sewing, gluing, welding or similar.

The truncated cone with the cylindrical central opening is filled with an organic material of the type Biomatrix Gold™, which material is particulate and has a structure that allows the entire volume of the fuel spillage interceptor, defined by the cloth material, to be filled in a uniform manner.

The fuel spillage interceptor is guided onto the dispensing nozzle, where it is kept in place by friction between the cylindrical surface 9 and the outside of the dispensing nozzle. It is of no importance to the functioning of the device which of the side faces 3, 7 face the mouth of the dispensing nozzle, however it may be of some aesthetic importance to have the design of the fuel spillage interceptor match the design of the dispensing nozzle.

When the dispensing nozzle is parked approximately upright on the pump, any fuel spillage on the mouth of the dispensing nozzle, in particular non-volatile diesel and similar, will run down the outside of the dispensing nozzle in the direction of the handle. The fuel spillage interceptor, which is mounted between the mouth and the handle of the dispensing nozzle, will intercept the spillage, and the Biomatrix Gold™-contents of the fuel spillage interceptor will effectively absorb the fuel. The characteristics of the fuel spillage interceptor allow large quantities of fuel to be collected before exhausting the capacity, and without any fuel being absorbed or adsorbed by the surface. This characteristic is beneficial in that it reduces the risk of transferring fuel to the operator's clothes or skin upon contact with the fuel spillage interceptor. The hydrophobic properties of the Biomatrix Gold™ ensure that the capacity of the fuel spillage interceptor is not reduced through contact with water from e.g. precipitation.

1. Liquid absorbent device in the form of a fuel spillage interceptor arranged for mounting on a fuel dispensing nozzle, the fuel spillage interceptor, having the shape of an essentially annular body and being formed from a cloth that is permeable to liquid and which defines a volume of at least one hydrocarbon liquid absorbent material, being arranged to enclose a portion of the spout of the dispensing nozzle, wherein the at least one hydrocarbon liquid absorbent material is particulate, desiccated hydrophobic sphagnum peat.

2. The liquid absorbent device in accordance with claim 1, wherein the at least one hydrocarbon liquid absorbent material is desiccated hydrophobic sphagnum peat of the type Biomatrix Gold™.
